(19) United States
(12) Patent Application Publication
(10) Pub. No.: US 2006/0032743 A1
(43) Pub. Date: Feb. 16, 2006

(54) Electrochemical measurement apparatus

(75) Inventor: Shinichi Harima, Daisen-city (JP)

Correspondence Address: MCDERMOTT WILL & EMERY LLP, 600 13TH STREET, N.W., WASHINGTON, DC, 20005-3096, US

(73) Assignee: TANITA CORPORATION

(21) Appl. No.: 11/196,280

(22) Filed: Aug. 4, 2005

(30) Foreign Application Priority Data
Aug. 11, 2004 (JP) 2004-234315

(51) Int. Cl. G01N 27/26

(52) U.S. Cl. 204/401

(57) ABSTRACT

Disclosed is an electrochemical measurement apparatus, which comprises an electrode group 6 for detecting a specific intra-environment substance in accordance with an electrochemical reaction caused by a working electrode 6b, a correction-equation storage part 11b storing a nonlinearity correction equation which includes an eigenvalue of an element forming a characteristic about a relationship between a detected value based on the detection by the electrode group 6 and a normal value of the specific intra-environment substance, and a nonlinearity-correction calculation part 11a for assigning the detected value based on the detection by the electrode group 6 to the nonlinearity correction equation to determine the normal value of the specific intra-environment substance.

### BACKGROUND OF THE INVENTION

1. Field of the Invention

The present invention relates to an apparatus for electrochemically measuring a specific substance in an environment such as liquid or gas.

2. Description of the Related Art

Heretofore, there has been known an apparatus for electrochemically measuring a reaction occurring between a specific substance in an environment and an electrode for sensing the specific substance, or an electrochemical measurement apparatus, such as an oxidation-reduction potentiometer, a pH meter, a residual chlorine meter or a water quality meter. Generally, the conventional electrochemical measurement apparatus is designed to detect a reaction occurring between a specific intra-environment substance and a sensing electrode, in the form, for example, of voltage or current, and utilize a conversion table representing a relationship between a detected value (voltage value, current value, etc.) obtained based on the reaction and a normal value (quantity, concentration, etc) of the specific intra-environment substance, so as to specify one normal value corresponding to the detected value to determine the specified normal value as a measured normal value of the specific intra-environment substance.

For example, the Patent Publication 1 (Japanese Patent Laid-Open Publication No. 2001-174431) discloses a residual-chlorine concentration meter, which is one type of the electrochemical measurement apparatuses. This residual chlorine concentration meter is designed to determine a concentration of residual chlorine contained in a liquid to be measured or a target liquid, using a conversion table for calculating a concentration value corresponding to a value of current induced by a reaction between a sensing electrode and the residual chlorine.

The above means for determining a normal value of a specific intra-environment substance can accurately determine the normal value, regardless of whether a relationship between a detected value based on an electrochemical reaction (hereinafter referred to as “reaction-based detected value”) and a value of the specific intra-environment substance has a proportional or linear characteristic, such as a relationship between a detection current (reduction current) and a concentration of residual chlorine in the residual-chlorine concentration meter disclosed in the Patent Publication 1 (see FIG. 3 in the Patent Publication 1), or a nonlinear characteristic, such as a relationship between an output (reaction-based detected value) and a concentration value (normal value of the specific substance as a measurement target), as shown in FIG. 13.

However, when the above relationship has a nonlinear characteristic, the apparatus is required to pre-store a number of concentration values (normal values of the specific substance as a measurement target) corresponding, respectively, to outputs (reaction-based signal value) at detection points over the entire measurement range, as shown in a conversion table of FIG. 14, which represents a relationship between an output (reaction-based detected value) and a concentration value (normal value of the specific substance as a measurement target). Thus, the conventional apparatus involves a problem about the need for a large storage capacity, which leads to increase in product cost.

The nonlinear characteristic in the relationship between the output (reaction-based detected value) and the concentration value (normal value of the specific substance as a measurement target) is created by an element (electrode, detection circuit, etc.) closely associated with the reaction occurring between a specific inter-environment substance and an electrode for sensing the specific inter-environment substance. Thus, if the configuration of the above element is changed in the design phase of the apparatus, the nonlinear characteristic in the relationship between the output (reaction-based detected value) and the concentration value (normal value of the specific substance as a measurement target) has to be figured out one again to prepare a new conversion table. Thus, the conventional apparatus also involves a problem about a time-consuming design process.

### BRIEF SUMMARY OF THE INVENTION

In view of the above conventional problems, it is therefore an object of the present invention to provide an electrochemical measurement apparatus capable of achieving a high degree of measurement accuracy at a low cost through a simplified design process.

In order to achieve the above object, the present invention provides an electrochemical measurement apparatus having an electrode group including a working electrode capable of electrochemically reacting with a specific substance in an environment, said electrode group being adapted to detect said specific substance in an environment based on the electromechanical reaction by said working electrode; a correction-equation storage part for storing a nonlinearity correction equation which represents a characteristic about a relationship between a detected value of said specific substance in an environment based on the detection by said electrode group and a normal value of said specific substance in an environment, and which is used for calculating said normal value based on said detected value, an eigenvalue of an element forming said characteristic, and a conversion coefficient value for converting said detected value to said normal value; and a nonlinearity-correction calculation part operable to assign said detected value of said specific substance in an environment based on the detection by said electrode group to said nonlinearity correction equation stored in said correction-equation storage part so as to calculate said normal value.

The electrochemical measurement apparatus of the present invention may further have a conversion-coefficient calculation part for calculating, as the conversion coefficient value, a ratio between the detected value of the specific substance in an environment based on the detection by the electrode group and a normal value of a calibration reference sample for which the normal value of the specific substance in an environment is known; and a conversion-coefficient storage part for rewritably storing the conversion coefficient value calculated by the conversion-coefficient calculation part. In this connection, the nonlinearity-correction calculation part may be operable to further assign the conversion coefficient value stored in the conversion-coefficient storage part to the nonlinearity correction equation stored in the correction-equation storage part so as to calculate the normal value.

The electrochemical measurement apparatus of the present invention may further have an impedance lowering circuit for lowering an impedance generated in the electrode group by the specific substance in an environment. In this connection, the eigenvalue of the element may be a rated impedance value of the impedance lowering circuit.

In the electrochemical measurement apparatus of the present invention, the nonlinearity correction equation may be represented as V=KR²/(KR−A), wherein: K is the detected value; R is the rated impedance value; A is the conversion coefficient value; and V is the normal value.

In the electrochemical measurement apparatus of the present invention, the eigenvalue of the element may be an area value of the working electrode.

In the electrochemical measurement apparatus of the present invention, the nonlinearity correction equation may be represented as V=−KS²/(KS−A), wherein: K is the detected value; S is an area value of the working electrode; A is the conversion coefficient value; and V is the normal value.

The electrochemical measurement apparatus of the present invention may further have an impedance lowering circuit for lowering an impedance generated in the electrode group by the specific substance in an environment. In this connection, the eigenvalue of the element is a rated impedance value of the impedance lowering circuit and an area value of the working electrode.

According the electrochemical measurement apparatus of the present invention, the electrode group is operable to detect the specific inter-environment substance in accordance with an electrochemical reaction caused by the working electrode, and the nonlinearity-correction calculation part is operable to assign a detected value based on the detection by the electrode group to the nonlinearity correction equation including the eigenvalue of the element forming the characteristic about the relationship between a detected value based on the detection by the electrode group and a normal value of the specific intra-environment substance, which is stored in the correction-equation storage part, so as to determine the normal value of the specific intra-environment substance as a measurement target. Thus, even if the relationship between the detected value based on the detection of the electrode group and the normal value of the specific intra-environment substance has a nonlinear characteristic, the normal value of the specific intra-environment substance can be accurately determined without the need for a large storage capacity. In addition, even if the configuration of one element is changed in the design phase, the nonlinear characteristic can be adequately modified only by altering the eigenvalue of the element. This makes it possible to provide the apparatus at a low cost through a simplified design process.

In particular, an area value of the working electrode and/or a rated impedance value of the impedance lowering circuit, which are closely associated with the reaction occurring between the working electrode and the specific intra-environment substance, may be used as the eigenvalue of the element forming the characteristic to provide enhanced accuracy.

Further, the conversion-coefficient storage part may be designed to rewritably store the additional conversion coefficient value indicative of a ratio between a known normal value of the specific substance contained in a calibration reference sample of the environment and a detected value of the specific intra-sample substance based on the detection by the electrode group, and the nonlinearity-correction calculation part may be designed to assign the additional conversion coefficient value to the nonlinearity correction equation so as to calculate the normal value. This makes it possible to facilitate the calibration so as to provide the apparatus at lower cost through a more simplified design process.

Other features and advantages of the present invention will be apparent from the accompanying drawings and from the detailed description.

### BRIEF DESCRIPTION OF THE DRAWINGS

FIG. 1 is an external view showing residual chlorine in the liquid concentration meter (electrochemical measurement apparatus) according to a first or second embodiment of the present invention.

FIG. 2 is a block diagram showing an electric/electronic system of the residual chlorine in the liquid concentration meter (electrochemical measurement apparatus) according to the first embodiment.

FIG. 3 is a flowchart showing an operation of the residual chlorine in the liquid concentration meter (electrochemical measurement apparatus) according to the first or second embodiment.

FIG. 4 is a block diagram showing another electric/electronic system of the residual chlorine in the liquid concentration meter (electrochemical measurement apparatus) according to the first embodiment.

FIG. 5 is a block diagram showing yet another electric/electronic system of the residual chlorine in the liquid concentration meter (electrochemical measurement apparatus) according to the first embodiment.

FIG. 6 is a graph showing the relationship between an output (inter-electrode voltage value based on the detection of residual chlorine in the liquid by an electrode group) and a concentration (normal concentration value of the residual chlorine in the liquid) under the condition that a resistance value is varied.

FIG. 7 is a graph showing nonlinearity under the condition that a resistance value is varied.

FIG. 8 is a block diagram showing an electric/electronic system of the residual chlorine in the liquid concentration meter (electrochemical measurement apparatus) according to the second embodiment.

FIG. 9 is an external view showing residual chlorine in the liquid concentration meter (electrochemical measurement apparatus) according to another embodiment of the present invention.

FIG. 10 is a block diagram showing an electric/electronic system of residual chlorine in the liquid concentration meter (electrochemical measurement apparatus) according to another embodiment of the present invention.

FIG. 11 is a graph showing the relationship between an output (inter-electrode voltage value based on the detection of residual chlorine in the liquid by an electrode group) and a concentration (normal concentration value of the residual chlorine in the liquid) under the condition that a resistance value is varied in the residual chlorine in the liquid concentration meter (electrochemical measurement apparatus) according to the second embodiment.

FIG. 12 is a graph showing nonlinearity under the condition that a resistance value is varied is varied in the residual chlorine in the liquid concentration meter (electrochemical measurement apparatus) according to the second embodiment.

FIG. 13 is a graph showing the relationship between an output (reaction-based detected value) and a concentration (normal value of a specific substance as a measurement target) in a conventional electrochemical measurement apparatus.

FIG. 14 is a diagram showing a conversion table representing the relationship between the output (reaction-based detected value) and the concentration (normal value of a specific substance as a measurement target) in the conventional electrochemical measurement apparatus.

### DETAILED DESCRIPTION OF THE INVENTION

An electrochemical measurement apparatus according to one embodiment of the present invention comprises a plurality of electrodes or an electrode group, a conversion-coefficient calculation part, a conversion-coefficient storage part, a correction-equation storage part, and a nonlinearity-correction calculation part.

The electrode group includes a working electrode capable of electrochemically reacting with a specific substance in an environment or a specific intra-environment substance. The electrode group is adapted to detect the specific intra-environment substance based on the electrochemical reaction caused by the working electrode.

The conversion-coefficient calculation part is operable to calculate, as a conversion coefficient value, a ratio between a known normal value of the specific substance contained in a calibration reference sample of the environment, and a detected value of the specific intra-sample substance based on the detection by the electrode group.

The conversion-coefficient storage part is operable to rewritably storing the conversion coefficient value calculated by the conversion-coefficient calculation part,

The correction-equation storage part stores a nonlinearity correction equation which represents a characteristic about a relationship between a detected value of the specific intra-environment substance based on the detection by the electrode group and a normal value of the specific intra-environment substance, and allows the normal value to be calculated therefrom in accordance with the detected value, an eigenvalue of an element forming the characteristic, and the conversion coefficient value for use in converting the detected value to the normal value.

The nonlinearity-correction calculation part is operable to assign the detected value of the specific intra-environment substance based on the detection by the electrode group and the conversion coefficient value stored in the conversion-coefficient storage part, to the nonlinearity correction equation stored in correction-equation storage part, so as to calculate the normal value.

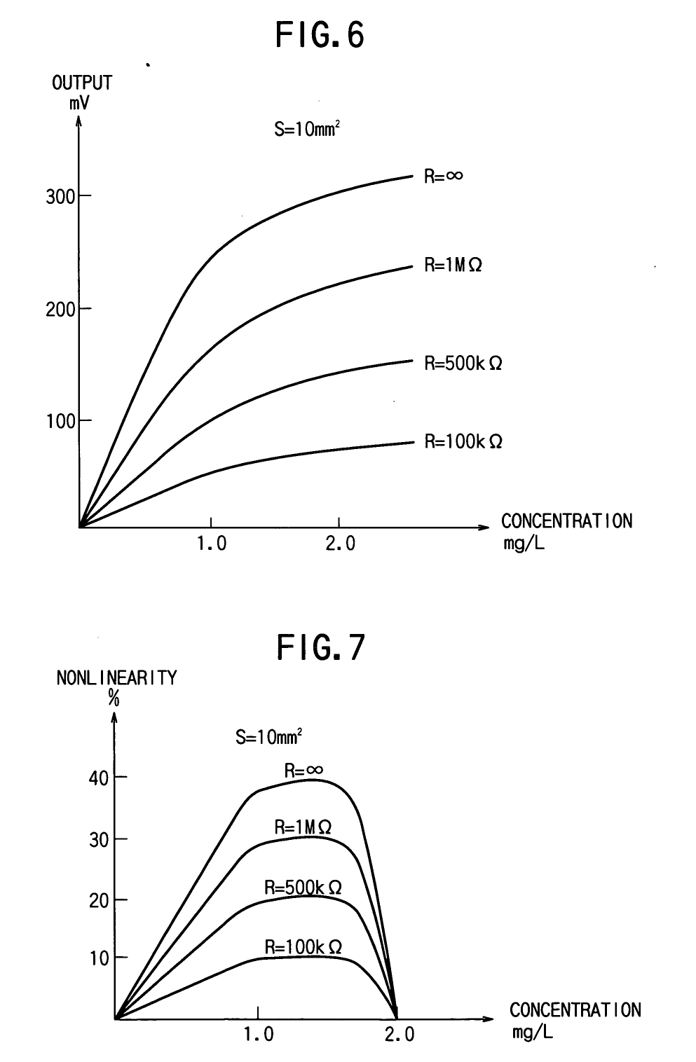

According the above electrochemical measurement apparatus according to this embodiment, the electrode group is operable to detect the specific inter-environment substance in accordance with an electrochemical reaction caused by the working electrode, and the nonlinearity-correction calculation part is operable to assign a detected value based on the detection by the electrode group to the nonlinearity correction equation including the eigenvalue of the element forming the characteristic about the relationship between a detected value based on the detection by the electrode group and a normal value of the specific intra-environment substance, which is stored in the correction-equation storage part, so as to determine the normal value of the specific intra-environment substance as a measurement target. Thus, even if the relationship between the detected value based on the detection of the electrode group and the normal value of the specific intra-environment substance has a nonlinear characteristic (see FIGS. 6, 7, 11 and 12), the normal value of the specific intra-environment substance can be accurately determined without the need for a large storage capacity. In addition, even if the configuration of one element is changed in the design phase, the nonlinear characteristic can be adequately modified only by altering the eigenvalue of the element. This makes it possible to provide the apparatus according to this embodiment at a low cost through a simplified design process.

Further, the conversion-coefficient storage part is operable to rewritably store the conversion coefficient value indicative of a ratio between a known normal value of the specific substance contained in a calibration reference sample of the environment and a detected value of the specific intra-sample substance based on the detection by the electrode group, and the nonlinearity-correction calculation part is operable to assign the conversion coefficient value stored in the conversion coefficient value to the nonlinearity correction equation so as to calculate the normal value. This makes it possible to facilitate the calibration so as to provide the apparatus according to this embodiment at lower cost through a more simplified design process.

In particular, at least one of an area value of the working electrode and/or a rated impedance value of the impedance lowering circuit may be effectively used as the eigenvalue of the element forming the characteristic, because the eigenvalue of the working electrode or the impedance lowering circuit is closely associated with the reaction occurring between the working electrode and the specific intra-environment substance.

The above embodiment will be described in more detail below in connection with residual chlorine in the liquid concentration meter as one type of electrochemical measurement apparatuses, wherein two types of residual chlorine in the liquid concentration meters using a rated impedance value (resistance value) of the impedance lowering circuit and an area value of the working electrode, as the eigenvalue of the element forming the characteristic, will be referred to, respectively, as “first and second embodiments”.

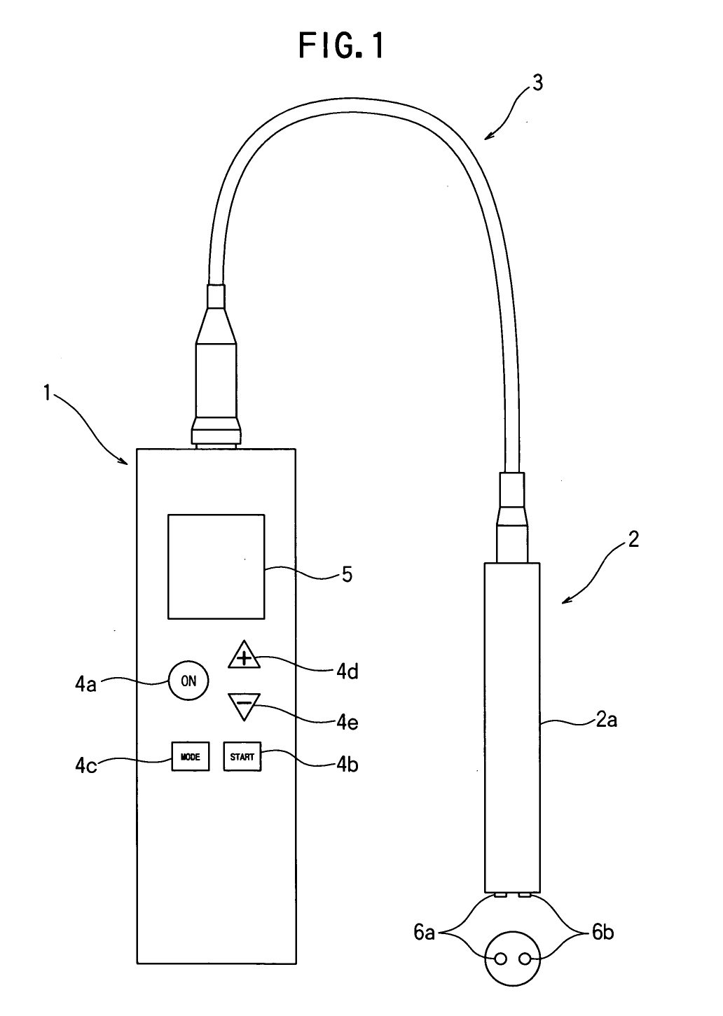

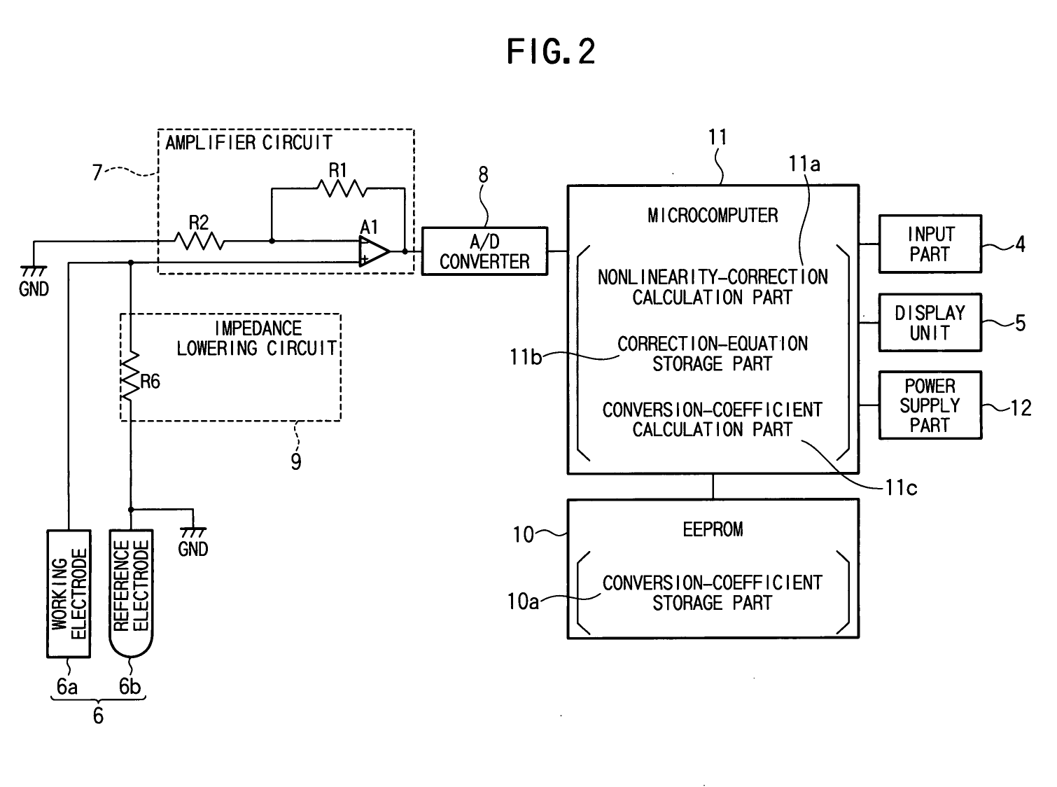

The residual chlorine in the liquid concentration meter according to the first embodiment will first be specifically described with reference to FIG. 1 showing an external view thereof and FIG. 2 showing an electric/electronic system thereof

The residual chlorine in the liquid concentration meter according to the first embodiment comprises, in external appearance, a body 1 having a front surface provided with an input part 4 and a display unit 5, a sensor unit 2 including an electrode group 6 consisting of a working electrode 6a and a reference electrode 6a, and a cable 3 electrically connecting between the body 1 and the sensor unit 2. The body 1 internally includes an amplifier circuit 7, an A/D converter 8, an impedance lowering circuit 9, an electronic circuit board having an EEPROM (Electronically Erasable and Programmable Read Only Memory) 10 and a microcomputer 11 formed thereon, and a power source part 12.

The input part 4 includes an ON key 4a, a start key 4b, a mode key 4c, an up (+) key 4d and a down (−) key 4e, and allows various instructions for power supply, measurement start, switching, and other operation to be entered therethrough. The ON key 4a is provided as a means to start supplying power from the power supply part 12 to each electric component. The start key 4b is provided as a means to start measurement or calibration. The mode key 4c is provided as a means to switch between a calibration mode and a measurement mode. The up and down keys 4d, 4e are provided as a means to set a normal concentration of a calibration reference liquid and select one of display items, numerical values, etc.

The display unit 5 is operable to display an input status, a measurement result, each of the modes, etc.

The sensor unit 2 has a bar-like or cylindrical housing 2a. The working and reference electrodes 6a, 6b are disposed at the distal end housing 2a in such a manner as to generate a certain potential indicative of the level of a reaction with residual chlorine when being immersed in a liquid containing the residual chlorine. The reference electrode 6b is formed of a silver (Ag) body coated with a silver chloride (AgCl) film, and adapted to generate a reference voltage when being immersed in the liquid.

The cable 3 has a conductive wire with one end electrically connected to the working and reference electrodes 6a, 6b of the sensor unit 2 and integrally formed with the sensor unit 2, and a connector for electrically connecting the other end to the electric circuit board in the body 1.

The power supply part 12 is adapted to supply power to each electric component.

The amplifier circuit 7 is operable to amplify an inter-electrode voltage (analog signal) generated between the working electrode 6a and the reference electrode 6b.

The A/D converter 8 is operable to convert the amplified inter-electrode voltage to a digital signal.

The impedance lowering circuit 9 is composed of a resistor R6 connected between the working electrode 6a and the reference electrode 6b, and operable to lower an impedance generated between the working and reference electrodes 6a, 6b immersed in the liquid.

The EEPROM 10 is operable to serve as a conversion-coefficient storage part 10a, and to store various other data. The conversion-coefficient storage part 10a is operable to rewritably store a conversion coefficient value calculated by the after-mentioned conversion-coefficient calculation part.

The microcomputer 11 includes a CPU, a ROM storing control and calculation programs, a RAM for temporarily storing a calculation result, an input datum, etc., a timer and an IO port. The microcomputer 11 is operable to serve as all of a conversion-coefficient calculation part 11c, a correction-equation storage part 11b and a nonlinearity-correction calculation part 11a, and to perform processing of various data, such as calculations and controls.

The conversion-coefficient calculation part 11c is operable to calculate, as a conversion coefficient value, a ratio between a known normal concentration value (known normal value) of residual chlorine contained in a calibration reference liquid and an inter-voltage value (detected value) of the residual chlorine in the liquid based on the detection by the electrode group 6.

The correction-equation storage part 11b stores a nonlinearity correction equation which represents a characteristic about a relationship between an inter-electrode voltage value (detected value) of the residual chlorine in the liquid based on the detection by the electrode group 6 and a normal concentration value (normal value) of the residual chlorine in the liquid, and allows the normal concentration value to be calculated therefrom in accordance with inter-electrode voltage value, a resistance value (constant) of the resistor R6 creating the characteristic, and a conversion coefficient value for converting the inter-electrode voltage value to the normal concentration value. More specifically, the inter-electrode voltage value based on the detection of the residual chlorine in the liquid by the electrode group 6 and the normal concentration value of the residual chlorine in the liquid have a curvilinear relationship as shown in FIG. 6. Thus, the correction-equation storage part stores, as the nonlinearity correction equation, the following equation (2) transformed from the following equation (1) representing a primitive characteristic of the above curve:
K=A{1/(V+R)−1/R} (1)
V=−KR²/(KR−A) (2)
wherein: K is the inter-electrode voltage value (detected value); K is the resistance value (constant); A is the conversion coefficient value; and V is the normal concentration value (normal value).

The nonlinearity-correction calculation part 11a is operable to assign the inter-electrode voltage value based on the detection of the residual chlorine in the liquid by the electrode group 6 and the conversion coefficient value stored in conversion-coefficient storage part 10a, respectively, to K and A of the nonlinearity correction equation (equation (2)) stored in the correction-equation storage part 11b, so as to calculate the normal concentration value of the residual chlorine in the liquid.

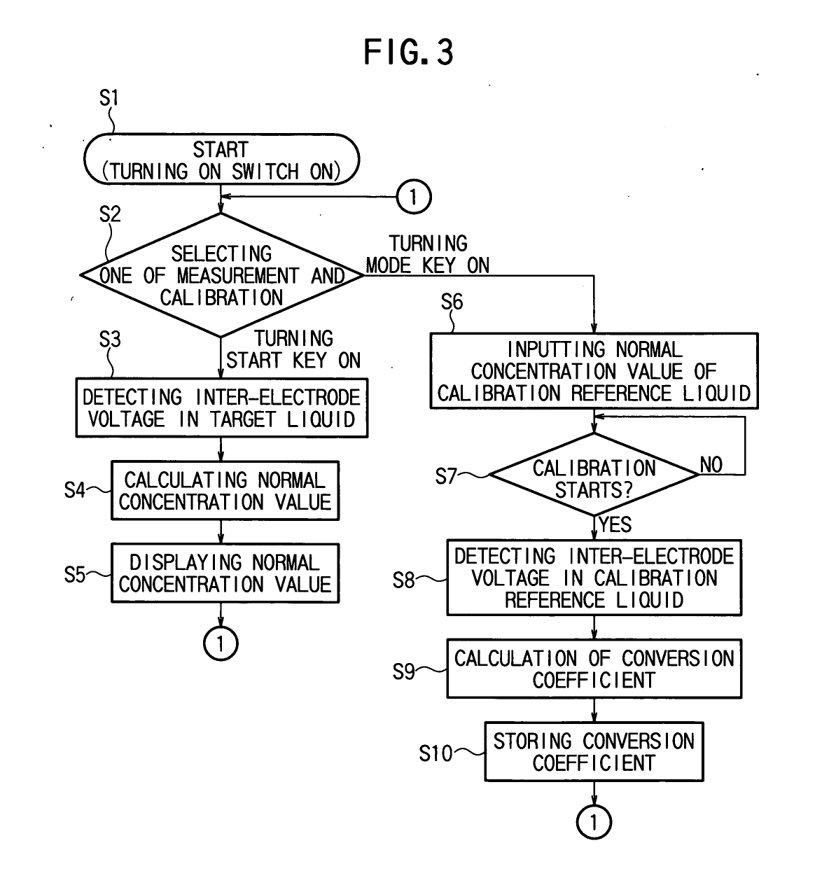

With reference to the flowchart in FIG. 3, a specific manipulation and operation of the residual chlorine in the liquid concentration meter according to the first embodiment will be described below.

When a user presses the ON key 4a, power is supplied from the power supply part to each electric component (Step S1). Then, the user selects either one of measurement and calibration (Step S2). If the mode key 4c is pressed (turning on of the mode key in Step S2), the calibration mode will start.

Then, in the calibration mode, when a normal concentration value of a calibration reference liquid is entered using the up and down keys 4d, 4e, the entered normal concentration value of the calibration reference liquid is temporarily stored in the RAM in the microcomputer 11 (Step S6).

Then, the user determines whether the calibration starts (Step S7). If the start key 4b is not pressed (the determination in Step S7 is NO), the current state will be maintained. When the electrode group 6 disposed at the tip of the sensor unit 2 is immersed in the calibration reference liquid, and the start key 4b is pressed (the determination in Step S7 is YES), the amplifier circuit 7 amplifies an inter-electrode voltage (analog signal) generated between the working and reference electrodes 6a, 6b immersed in the calibration reference liquid, and the A/D converter 8 converts the amplified analog signal to a digital signal. Then, the microcomputer 11 retrieves the digital signal (Step S8).

Then, the conversion-coefficient calculation part 11c calculates, as a conversion coefficient value, a ratio between the retrieved inter-electrode voltage value and the normal concentration value of the calibration reference liquid temporarily stored in the RAM (Step S9), and the conversion-coefficient storage part 10a stores the calculated conversion coefficient value (Step S10).

Then, the process returns to Step S2 to get ready for repeating the above steps.

In Step S2 for selecting either one of measurement and calibration, if the electrode group 6 disposed at the tip of the sensor unit 2 is immersed in a target liquid to be measured, and the start key 4b is pressed (turning on the start key in Step S2), the amplifier circuit 7 amplifies an inter-electrode voltage (analog signal) generated between the working and reference electrodes 6a, 6b immersed in the target liquid, and the A/D converter 8 converts the amplified analog signal to a digital signal. Then, the microcomputer 11 retrieves the digital signal (Step S3).

Then, the nonlinearity-correction calculation part assigns the retrieved inter-electrode voltage value and the conversion coefficient value stored in conversion-coefficient storage part, respectively, to K and A of the nonlinearity correction equation (equation (2)) stored in the correction-equation storage part, so as to calculate the normal concentration value of the residual chlorine in the target liquid (Step S4), and the display unit 5 displays the calculated normal concentration value of the residual chlorine in the target liquid (Step S5).

Then, the process returns to Step S2 to get ready for repeating the above steps.

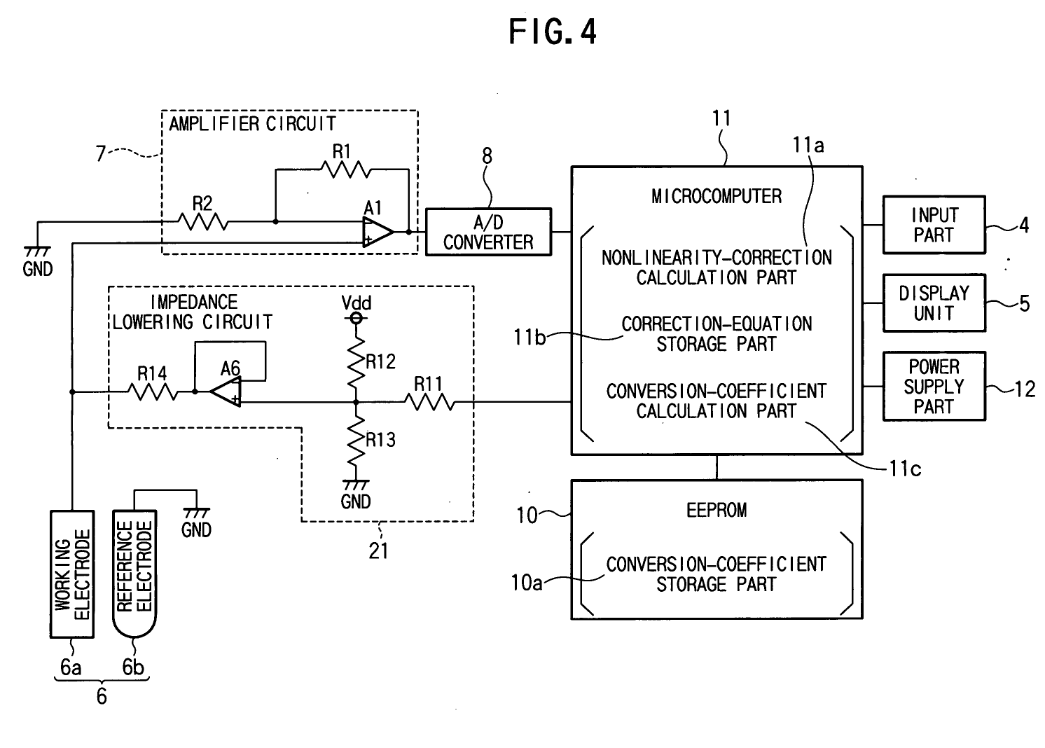

The first embodiment using a rated impedance value (resistance value) of the impedance lowering circuit as the eigenvalue of the element forming the characteristic has been described as above. While the impedance lowering circuit 9 in the first embodiment consists only of the resistor R6, a combination of a voltage forming circuit (R11, R12, R13) for forming a voltage, a voltage follower connected to the voltage forming circuit, and an output resistor R14 connected between the voltage follower and the working electrode 6a may be provide to form an impedance circuit 21, as shown in FIG. 4.

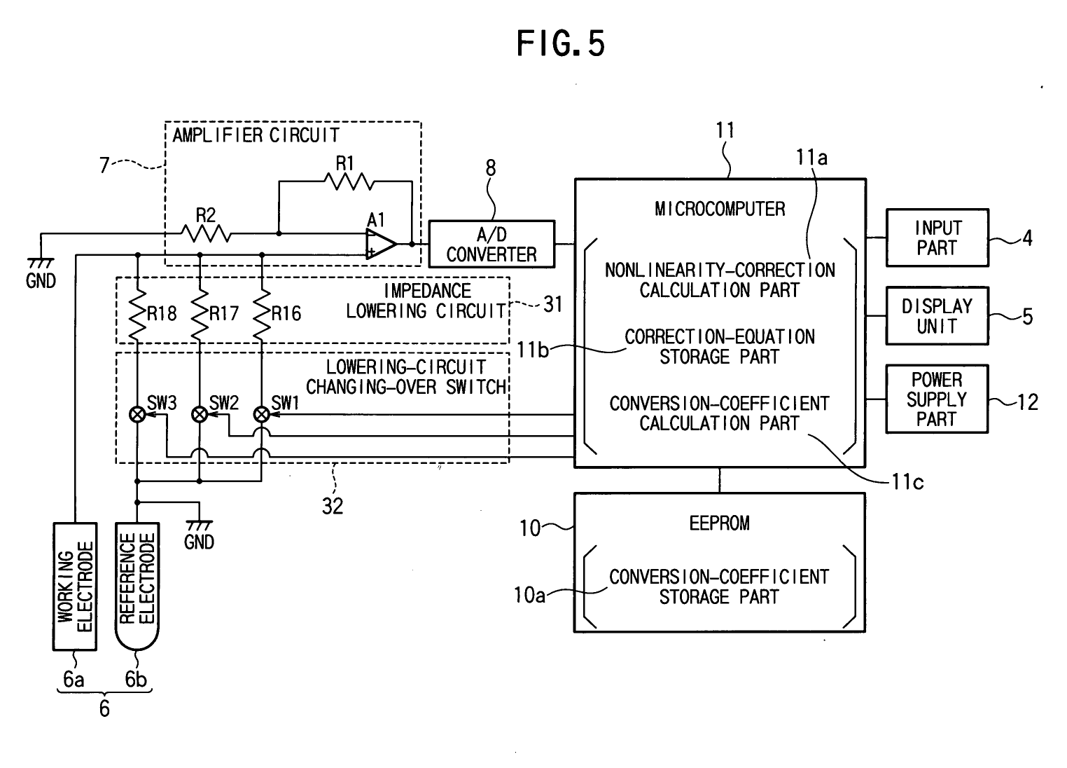

Further, instead of the single resistor R6 as the impedance lowering circuit 9 in the first embodiment, a plurality of resistors R16, R17, R18 different in resistance value (rated impedance value) may be provided to form an impedance lowering circuit 31, as shown in FIG. 5, and a plurality of changing-over switches Sw1, Sw2, Sw3 may be connected, respectively, to the resistors R16, R17, R18 to switch between them under the control of the microcomputer 11 for different purposes.

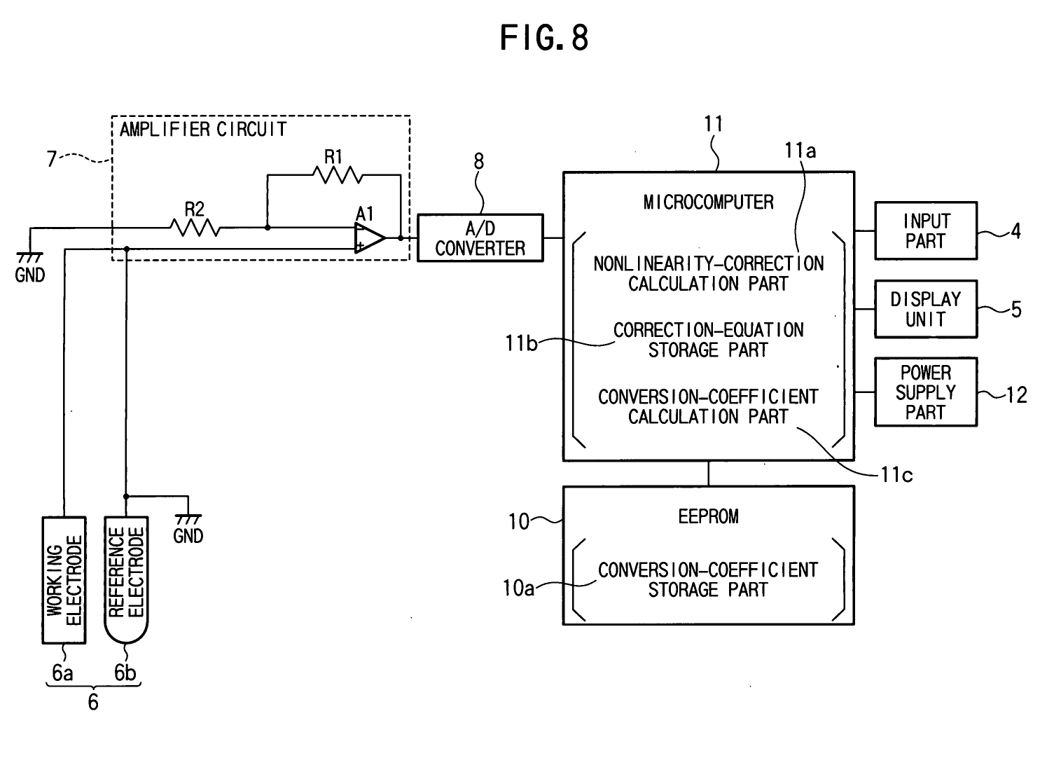

The residual chlorine in the liquid concentration meter according to the second embodiment will be specifically described below with reference to FIG. 8 showing a block diagram of an electric/electronic system thereof and FIG showing a flowchart of an operation thereof.

As compared with the first embodiment, the residual chlorine in the liquid concentration meter according to the second embodiment is different in that the impedance circuit 9 is eliminated and the nonlinearity correction equation to be stored in the correction-equation storage part 11b is changed. The remaining structure and the manipulation/operation are the same as those in the first embodiment. Thus, their duplicated description will be omitted, and the following description will be made with a focus on the differences.

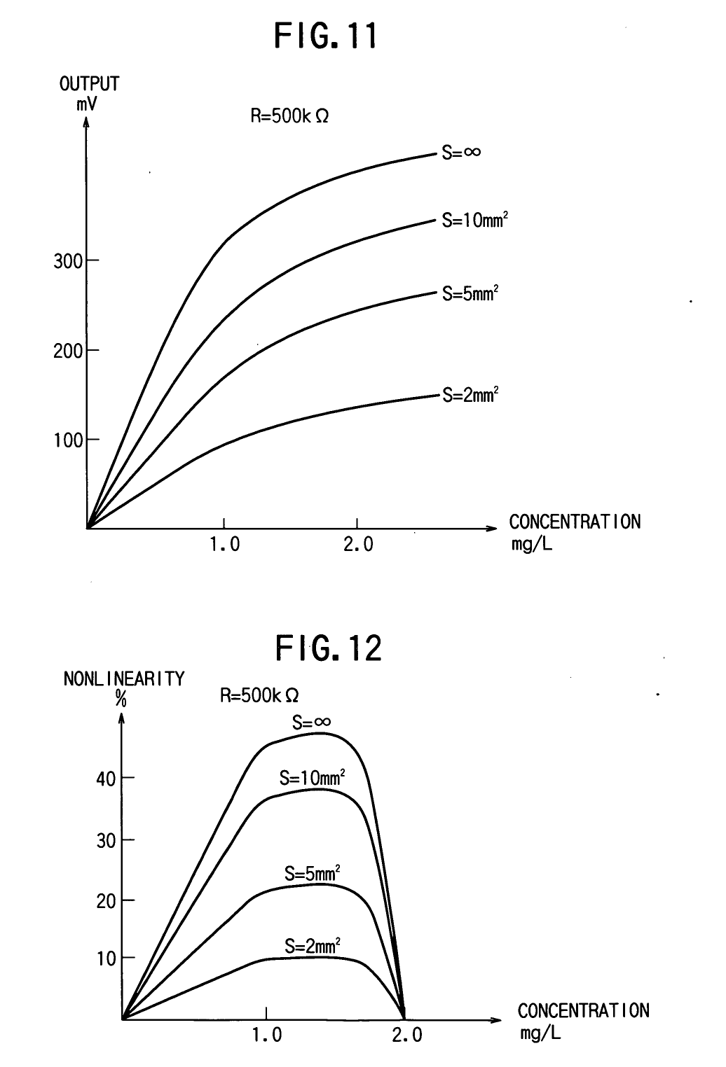

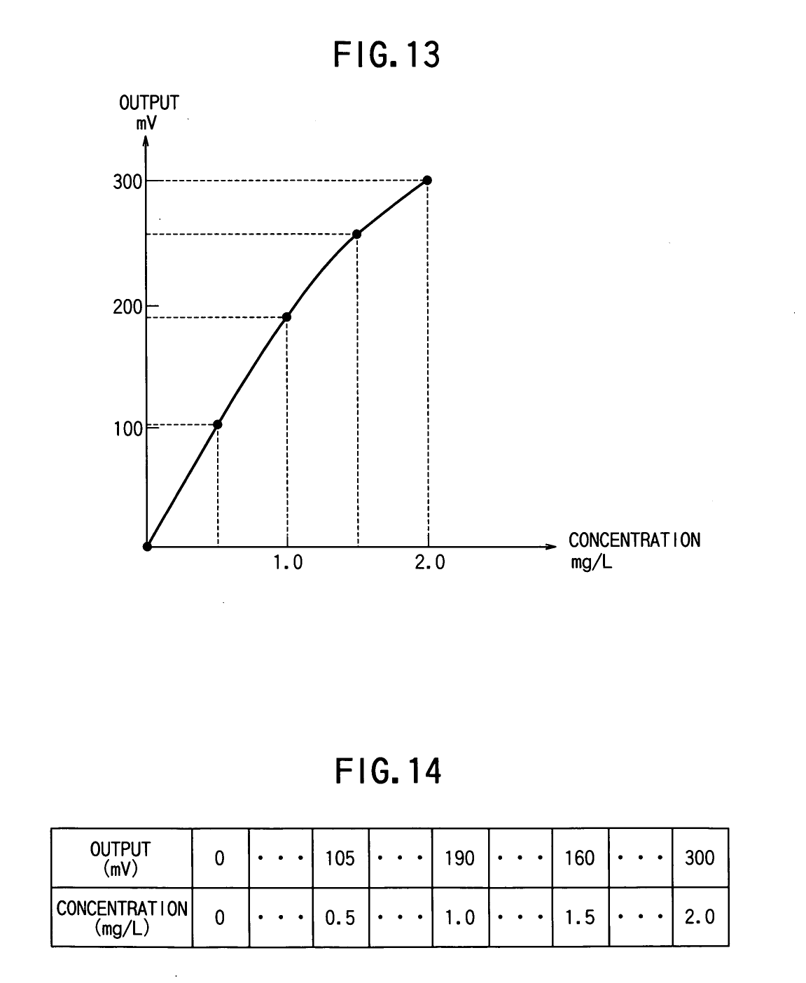

A correction-equation storage part 11b stores a nonlinearity correction equation which represents a characteristic about a relationship between an inter-electrode voltage value (detected value) based on the detection of the residual chlorine in the liquid by the electrode group 6 and a normal concentration value (normal value) of the residual chlorine in the liquid, and allows the normal concentration value to be calculated therefrom in accordance with the inter-electrode voltage value, an area value (constant) of the working electrode 6a creating the characteristic, and a conversion coefficient value for converting the inter-electrode voltage value to the normal concentration value. More specifically, the inter-electrode voltage value based on the detection of the residual chlorine in the liquid by the electrode group 6 and the normal concentration value of the residual chlorine in the liquid have a curvilinear relationship as shown in FIG. 11. Thus, the correction-equation storage part stores, as the nonlinearity correction equation, the following equation (4) transformed from the following equation (3) representing a primitive characteristic of the above curve:
K=A{1/(V+S)−1/S} (3)
V=−KS²/(KS−A) (4)
wherein: K is the inter-electrode voltage value (detected value); S is the area value (constant); A is the conversion coefficient value; and V is the normal concentration value (normal value).

Further, in Step S4, the nonlinearity-correction calculation part 11a assigns the retrieved inter-electrode voltage value and the conversion coefficient value stored in conversion-coefficient storage part 10a, respectively, to K and A of the nonlinearity correction equation (equation (4)) stored in the correction-equation storage part 11b, so as to calculate the normal concentration value of the residual chlorine in the liquid.

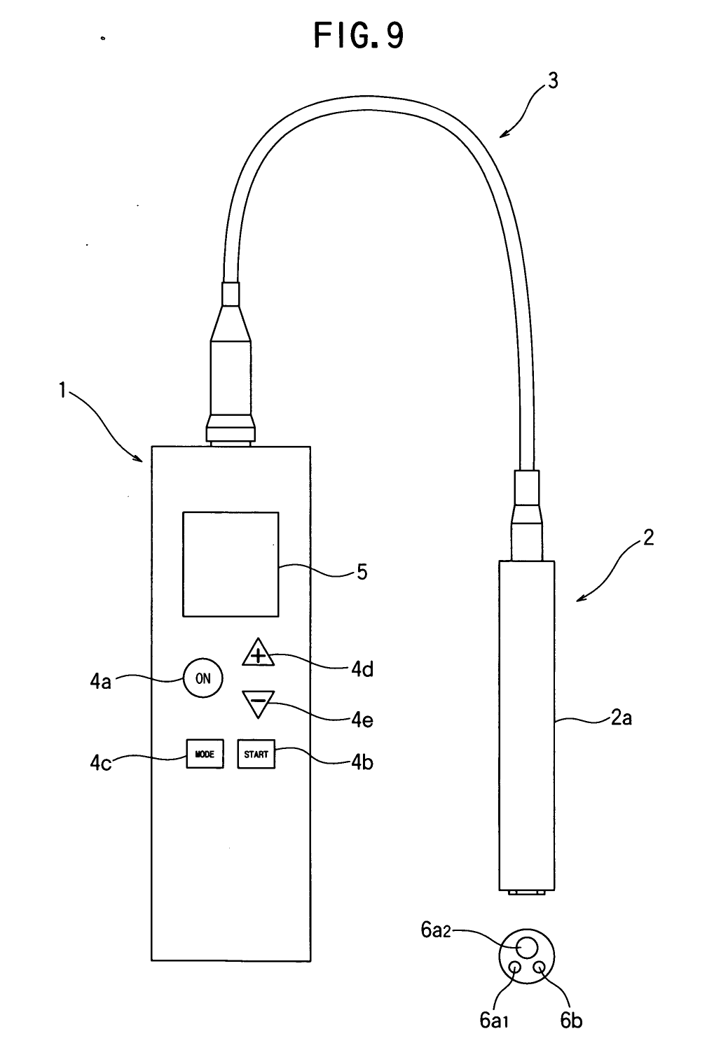

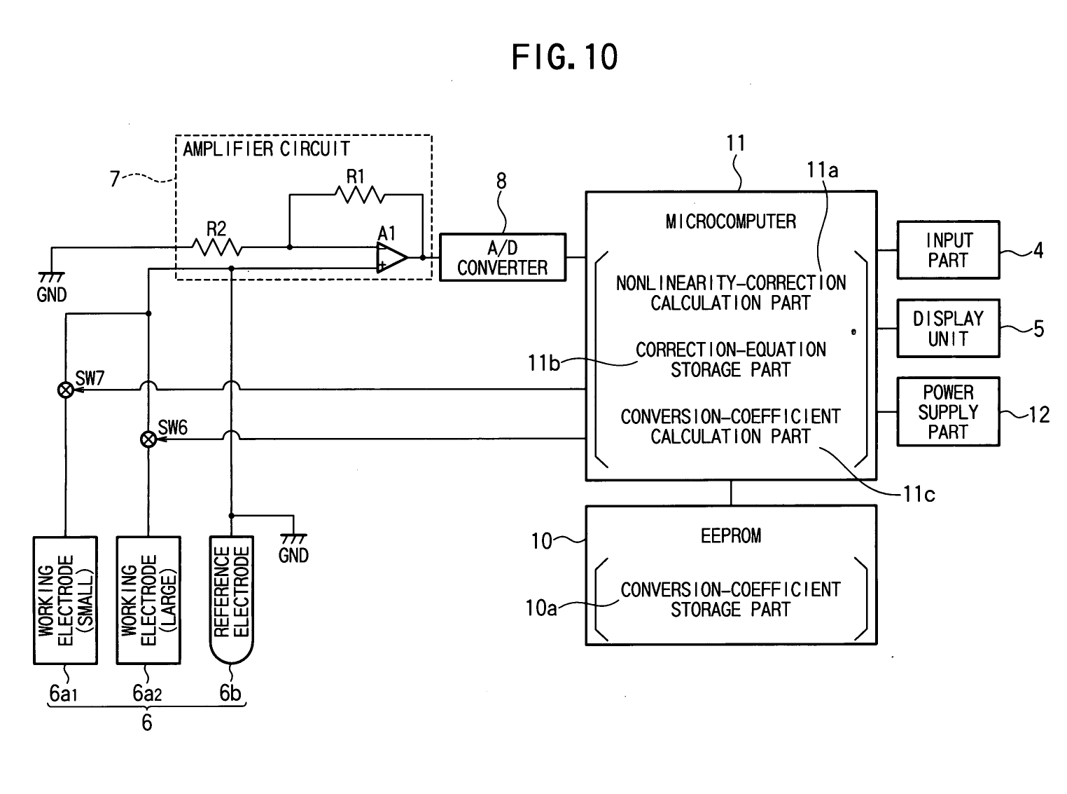

The second embodiment using an area value of the working electrode as the eigenvalue of the element forming the characteristic has been described as above. While the concentration meter according to the second embodiment has been designed to have a single working electrode, a plurality of working electrodes 6a1, 6a2 different in area value may be provided, as shown in FIGS. 9 and 10, and a plurality of changing-over switches Sw6 and Sw7 may be connected, respectively, to the working electrodes 6a1, 6a2 to switch between them under the control of the microcomputer 11 for different purposes.

Advantageous embodiments of the invention have been shown and described. It is obvious to those skilled in the art that various changes and modifications may be made therein without departing from the spirit and scope thereof as set forth in appended claims. For example, while each concentration meter according to the above first and second embodiments has been designed to have the eigenvalue of the element forming the characteristic consisting only of either one of a rated impedance value of the impedance lowering circuit and an area value of the working electrode, the eigenvalue of the element forming the characteristic used for the nonlinear correction equation stored in the correction-equation storage part 11b may include both a rated impedance value of the impedance lowering circuit and an area value of the working electrode. Further, the eigenvalue of the element forming the characteristic is not limited to a rated impedance value of the impedance lowering circuit or an area value of the working electrode, but any other suitable eigenvalue of an element closely associated with a reaction occurring between an intra-environment substance and an electrode for sensing intra-environment substance may be used.

Furthermore, while the electrode group in the above first and second embodiments has been composed of the working electrode and the reference electrode, and designed to detect an inter-electrode voltage, it may include a working electrode, a reference electrode and a standard reference electrode, and designed to detect a current generated between the reference electrode and the standard reference electrode.

What is claimed is:

1. An electrochemical measurement apparatus comprising:
an electrode group including a working electrode capable of electrochemically reacting with a specific substance in an environment, said electrode group being adapted to detect said specific substance in an environment based on the electrochemical reaction by said working electrode;
a correction-equation storage part for storing a nonlinearity correction equation which represents a characteristic about a relationship between a detected value of said specific substance in an environment based on the detection by said electrode group and a normal value of said specific substance in an environment, and which is used for calculating said normal value based on said detected value, an eigenvalue of an element forming said characteristic, and a conversion coefficient value for converting said detected value to said normal value; and
a nonlinearity-correction calculation part operable to assign said detected value of said specific substance in an environment based on the detection by said electrode group to said nonlinearity correction equation stored in said correction-equation storage part so as to calculate said normal value.

2. The electrochemical measurement apparatus according to claim 1, further comprising:
a conversion-coefficient calculation part for calculating, as the conversion coefficient value, a ratio between said detected value of said specific substance in an environment based on the detection by said electrode group and a normal value of a calibration reference sample for which the normal value of the specific substance in an environment is known; and
a conversion-coefficient storage part for rewritably storing the conversion coefficient value calculated by said conversion-coefficient calculation part,
wherein said nonlinearity-correction calculation part is operable to further assign the conversion coefficient value stored in said conversion-coefficient storage part to said nonlinearity correction equation stored in said correction-equation storage part so as to calculate said normal value.

3. The electrochemical measurement apparatus according to claim 1 or 2, further comprising:
an impedance lowering circuit for lowering an impedance generated in said electrode group by said specific substance in an environment,
wherein said eigenvalue of the element is a rated impedance value of said impedance lowering circuit.

4. The electrochemical measurement apparatus according to claim 3, wherein said nonlinearity correction equation is represented as V=−KR²/(KR−A), wherein: K is the detected value; R is the rated impedance value; A is the conversion coefficient value; and V is the normal value.

5. The electrochemical measurement apparatus according to claim 1 or 2, wherein the eigenvalue of said element is an area value of said working electrode.

6. The electrochemical measurement apparatus according to claim 5, wherein said nonlinearity correction equation is represented as V=−KS²/(KS−A), wherein: K is the detected value; S is an area value of said working electrode; A is the conversion coefficient value; and V is the normal value.

7. The electrochemical measurement apparatus according to claim 1 or 2, further comprising:
an impedance lowering circuit for lowering an impedance generated in said electrode group by said specific substance in an environment,
wherein said eigenvalue of the element is a rated impedance value of said impedance lowering circuit and an area value of said working electrode.
